(19) United States
(12) Patent Application Publication
(10) Pub. No.: US 2020/0376681 A1
(43) Pub. Date: Dec. 3, 2020

(54) POSITION/FORCE CONTROL DEVICE

(71) Applicants: KEIO UNIVERSITY, Minato-ku, Tokyo (JP); Motion Lib, Inc., Kanagawa (JP)

(72) Inventors: Kouhei OHNISHI, Yokohama-shi, Kanagawa (JP); Takahiro NOZAKI, Yokohama-shi, Kanagawa (JP); Takahiro MIZOGUCHI, Kawasaki-shi, Kanagawa (JP); Wataru IIDA, Kawasaki-shi, Kanagawa (JP)

(73) Assignees: KEIO UNIVERSITY, Minato-ku, Tokyo (JP); Motion Lib, Inc., Kanagawa (JP)

(21) Appl. No.: 16/772,180

(22) PCT Filed: Dec. 14, 2018
(86) PCT No.: PCT/JP2018/046206

§ 371 Date: Jun. 12, 2020

(30) Foreign Application Priority Data
Dec. 14, 2017 (JP) 2017-239964

(51) Int. Cl. B25J 13/08; G06F 3/01; B25J 9/00; G05D 3/20; G05D 15/01

(52) U.S. Cl. CPC B25J 13/084; G06F 3/011; G05D 15/01; G05D 3/20; B25J 9/0081

(57) ABSTRACT

Provided is technology for more appropriately realizing a human physical-act using a robot. This position/force control device comprises: an act time information retaining means for retaining a time interval or a time stamp of an act, in addition to act information when the act is recorded; a control reference information generation means for generating, from the recorded act information, information to serve as a control reference when the act is replicated; a control timing determination means for determining, from the recorded act time information, a timing for outputting the control reference information when the act is replicated; and a position/force control means for replicating the act on the basis of the generated control reference information and the determined control timing.

### TECHNICAL FIELD

The present invention relates to a position/force control device for controlling a position and a force of a control target.

### BACKGROUND ART

Against the background of a declining birthrate, an aging population, etc., it has beer strongly desired that robots conduct work requiring manpower and labor for human beings. However, the motion of conventional robots lacks environmental adaptability and flexibility, and has not yet come to suitably realize a physical action of a human being. In this regard, an attempt has been made to artificially reproduce motion of an actuator by using time-series position information and force Information acquired by a master-slave system. However, mechanical impedance at the time of reproduction is always constant, and adaptability to environmental variations such as the position, size, and mechanical impedance of the environment remains to be achieved. A technique relating to a robot that is remotely controlled by way of the master-slave system is disclosed in, for example, Patent Documents 1 and 2.

Patent Document 1: PCT International Publication No. WO2005/109139

### Patent Document 2: Japanese Unexamined Patent Application, Publication No. 2009-279699

### DISCLOSURE OF THE INVENTION

### Problems to be Solved by the Invention

In order to cause a robot to suitably conduct such manpower- and labor-consuming work for a human being, it is very important to achieve highly precise force control resulting in advanced adaptability to the environment and to extract an action in human coordinate system by way of a multi-degree-freedom system. However, the known techniques nave not yet solved these challenges. That is, the known techniques to realize a human physical action using a robot have room for improvement. It is an object or the present invention to provide a technique to cause a robot to realize a physical action of a human being more suitably.

### Means for Solving the Problems

To achieve the above object, a position/force control device according to one aspect of the present invention includes: a force/velocity allocation-by-function transformer that performs transformation to allocate control energy to energy of velocity or position and energy of force in accordance with a function to be implemented, based on information of velocity (position) and force corresponding to information about position that is based on an operation of an actuator, and information serving as a reference of control; a position control amount calculator that calculates a control amount of velocity or position, based on the energy of velocity or position allocated by the force/velocity allocation-by-function transformer; a force control amount calculator that calculates a control amount of force, based on the energy of force allocated by the force/velocity allocation-by-function. transformer; a combiner that combines the control amount of velocity or position with the control amount of force, and in order to return a resultant output to the actuator, inversely transforms the control amount of velocity or position and the control amount of force, and thereby determines an input to the actuator; an action time information retainer that retains not only action information, but also time intervals of an action or time stamps while the action is recorded; a control reference information generator that generates, from recorded action information, information serving as a control reference while the action is re-executed; a control timing determiner that determines, from recorded action time information, timing at which control reference information is outputted while the action is re-executed; and a position/force controller that re-executes the action, based on the generated control reference information and the determined control timing, the position/force control device enabling the action to be re-executed at the same time intervals as those in recording of the action.

### Effects of the Invention

The present invention provides a technique to cause a robot to realize a physical action of a human being more suitably.

### BRIEF DESCRIPTION OF THE DRAWINGS

FIG. 1 is a schematic diagram illustrating a concept of a basic principle of the present invention;

FIG. 2 is a schematic diagram illustrating a concept of control in a case where a force/haptic sense transmission function is defined by a force/velocity allocation-by-function transformation block FT;

FIG. 3 is a schematic diagram illustrating a concept of a master-slave system to which a force/haptic sense transmission function is applied and which includes a master device and a slave device;

FIG. 4 is a schematic diagram illustrating a concept of control in a case where a pick-and-place function is defined by the force/velocity allocation-by-function transformation block FT;

FIG. 5 is a schematic diagram illustrating a concept of a robot arm system to which a pick-and-place function is applied and which includes a first arm and a second arm;

FIG. 6 is a schematic diagram illustrating a concept of control in a case where a function of learning and reproducing how to turn a screw is defined by the force/velocity allocation-by-function transformation block FT;

FIG. 7 is a schematic diagram illustrating a robot to which a function of learning and reproducing how to turn a screw is applied;

FIG. 8 is a schematic diagram showing a basic configuration of a position/force control device 1 according to the present invention;

FIG. 9 is a schematic diagram showing a configuration of a position/force control device 1 configured to swing a rod member with the help of an actuator;

FIG. 10 is a schematic diagram (top view) showing a configuration of a position/force control device 2 which is constituted by a combination position/force control devices 1A, 1B having the configuration shown in FIG. 9, and is embodied as a chopstick-type grasping device;

FIG. 11 is a schematic diagram showing a configuration in which position/force control devices 2A, 2B having the configuration shown in FIG. 10 are combined to form a master-slave type grasping device;

FIG. 12 is a schematic diagram showing an example of a data format in the case of recording a physical action of a human being;

FIG. 13 is a schematic diagram showing another example of a data format in the case of recording a physical action of a human being;

FIG. 14 is a schematic diagram illustrating an example of a result of re-execution of a recorded action in a case where no information about recording time intervals has been recorded.

FIG. 15 is a schematic diagram illustrating an example of a result of re-execution of a recorded action in a case where information about recording time intervals has been recorded;

FIG. 16 is a schematic diagram showing a configuration of a position/force control device 3 provided with a camera as an environment recognizer;

FIG. 17 is a flowchart showing contents (a combination of rules) of a standby action;

FIG. 18 is a flowchart showing contents (a combination of rules) of a grasping action;

FIG. 19 is a schematic diagram showing a configuration of a position/force control device 1 that estimates object properties while pushing a solid;

FIG. 20 is a schematic diagram showing a configuration or a position/force control device 1 that estimates object properties while moving a solid;

FIG. 21 is a schematic diagram showing a configuration of a position/force control device 1 that estimates object properties while cutting a solid; and

FIG. 22 is a schematic diagram showing a configuration of a position/force control device 1 that estimates object properties while applying liquid.

### PREFERRED MODE FOR CARRYING OUT THE INVENTION

Embodiments of the present invention will be described with reference to the drawings. First, a basic principle is described which is applied to a position/force control device, a position/force control method, and a position/force control program according to the present invention.

Note that a physical action of a human being is constituted by an individual “function” of one joint or the like, or is composed of a combination of such “functions”. Therefore, in the following description of the present embodiment, the term “action” is defined to represent an integrated function composed of individual “functions” of parts of a human body. For example, an action involving bending and unbending knuckles of a middle finger (e.g., an action of turning a screw) is an integrated function composed of functions of the knuckles of the middle finger.

### Basic Principle

The basic principle of the present invention is described as follows. Any action can be mathematically expressed with three elements, namely, a force source, a velocity (position) source, and a transformation representing the action. Accordingly, by supplying control energy from an ideal force source and an ideal velocity (position) source which are in a duality relationship with a set of variables defined by a transformation and an inverse transformation, to a system as a control target, an extracted physical action is structuralized, reconstructed or expanded and amplified, so that the physical action is automatically realized (reproduced) in a reversible manner.

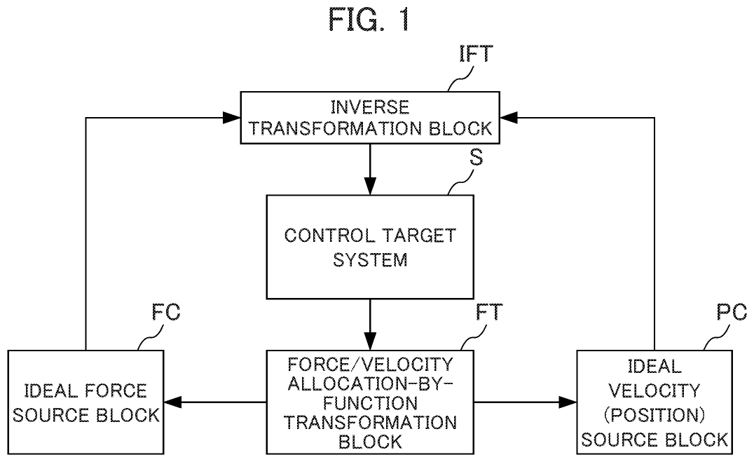

FIG. 1 is a schematic diagram illustrating the concept of the basic principle of the present invention. The basic principle shown in FIG. 1 represents a control law of an actuator usable for realizing a physical action of a human being. According to the control law, a current position of the actuator is utilized as an input, and an arithmetic operation is performed in at least one of a region of position (or velocity) or a region of force, whereby motion of the actuator is determined. That is, the basic principle of the present invention is represented as a control law including a control target system S, a force/velocity allocation-by-function transformation block FT, at least one of an ideal force source block FC or an ideal velocity (position) source block PC, and an inverse transformation block IFT.

The control target system S is a robot operable by the actuator, and controls the actuator based on acceleration or the like. Here, the control target system S is configured to realize a function of one or more parts of a human body. As long as the control law for realizing the function is applied, the specific configuration of the control target system S does not necessarily need to have a shape simulating the human body. For example, the control target system S can be embodied as a robot that causes a link to perform one-dimensional sliding motion with the help of an actuator.

The force/velocity allocation-by-function transformation block FT is a block that defines a transformation of control energy into the region of velocity (position) and the region of force, the transformation being set according to the function of the control target system S. Specifically, in the force/velocity allocation-by-function transformation block FT, a coordinate transformation is defined in which a value (reference value) serving as a reference of the function of the control target system S and a current position of the actuator are utilized as inputs. Generally, by this coordinate transformation, an input vector having the reference value and a current velocity (position) as elements is transformed into an output vector consisting of a velocity (position) for calculation of a control target value of velocity position), and an input vector having the reference value and a current force as elements is transformed into an output vector consisting of a force for calculation of a control target value of force. Specifically, the coordinate transformation in the force/velocity allocation-by-function transformation block FT is generalized and represented as Formulas (1) and (2) below.

$$\begin{matrix}( \begin{matrix}{\dot{x}}_{1} \\ {\dot{x}}_{2} \\ ⋮ \\ {\dot{x}}_{n - 1} \\ {\dot{x}}_{n}\end{matrix} ) = ( \begin{matrix}{h}_{1 a} & {h}_{1 b} & ⋯ & {h}_{1 ( m - 1 )} & {h}_{1 m} \\ {h}_{2 a} & {h}_{2 b} & ⋯ & {h}_{2 ( m - 1 )} & {h}_{2 m} \\ ⋮ & ⋮ & ⋱ & ⋮ & ⋮ \\ {h}_{( n - 1 ) a} & {h}_{( n - 1 ) b} & ⋯ & {h}_{( n - 1 ) ( m - 1 )} & {h}_{( n - 1 ) m} \\ {h}_{na} & {h}_{nb} & ⋯ & {h}_{n ( m - 1 )} & {h}_{nm}\end{matrix} ) ( \begin{matrix}{\dot{x}}_{a} \\ {\dot{x}}_{b} \\ ⋮ \\ {\dot{x}}_{m - 1} \\ \dot{{x}_{m}}\end{matrix} ) & ( 1 ) \\ ( \begin{matrix}{f}_{1} \\ {f}_{2} \\ ⋮ \\ {f}_{n - 1} \\ {f}_{n}\end{matrix} ) = ( \begin{matrix}{h}_{1 a} & {h}_{1 b} & ⋯ & {h}_{1 ( m - 1 )} & {h}_{1 m} \\ {h}_{2 a} & {h}_{2 b} & ⋯ & {h}_{2 ( m - 1 )} & {h}_{2 m} \\ ⋮ & ⋮ & ⋱ & ⋮ & ⋮ \\ {h}_{( n - 1 ) a} & {h}_{( n - 1 ) b} & ⋯ & {h}_{( n - 1 ) ( m - 1 )} & {h}_{( n - 1 ) m} \\ {h}_{na} & {h}_{nb} & ⋯ & {h}_{n ( m - 1 )} & {h}_{nm}\end{matrix} ) ( \begin{matrix}{f}_{a} \\ {f}_{b} \\ ⋮ \\ {f}_{m - 1} \\ {f}_{m}\end{matrix} ) & ( 2 )\end{matrix}$$

Note that in Formula (1), x′₁ to x′ₙ (where n is an integer equal to or greater than 1) are velocity vectors for deriving a state value of velocity; x′ₐ to x′ₘ (where m is an integer equal to or greater than 1) are vectors having, as elements, the reference value and a velocity based on an operation of the actuator (a velocity of a movable component of the actuator or a velocity of a target object moved by the actuator); and h₁ₐ to hₙₘ are elements of a transformation matrix representing a function. In Formula (2), f″₁ to f″ₙ (n is an integer equal to or greater than 1) are force vectors for deriving a state value of force; and f″ₐ to f″ₘ (m is an integer equal to or greater than 1) are vectors having, as elements, the reference value and a force based on an operation of the actuator (a force of the movable component of the actuator or a force of the target object moved by the actuator). Setting the coordinate transformation of the force/velocity allocation-by-function transformation block FT according to a function to be realized makes it possible to realize various actions or to reproduce an action involving scaling. That is, according to the basic principle of the present invention, in the force/velocity allocation-by-function transformation block FT, a variable of the actuator alone (a variable in a real space) is “transformed” into a set of variables of the entire system representing a function to be realized (variables in a virtual space), and control energy is allocated to control energy of velocity (position) and control energy of force. This makes it possible to provide the control energy of velocity (position) and the control energy of force independently from each other, as compared with the case where the control is performed with the variable of the actuator alone (the variable in the real space) being as it is.

The ideal force source block FC is a block that performs an arithmetic operation in the region of force, according to the coordinate transformation defined by the force/velocity allocation-by-function transformation block FT. The ideal force source block FC has therein a target value related to a force for performing an arithmetic operation based on the coordinate transformation defined by the force/velocity allocation-by-function transformation block FT. This target value is set as a fixed value or a variable value according to the function to be realized. For example, in the case of realizing a function similar to the function indicated by the reference value, the target value can be set to be zero. In the case of performing scaling, the target value can be set to be a value obtained by enlarging or reducing information indicating the function to be reproduced.

The ideal velocity (position) source block PC is a block that performs an arithmetic operation in the region of velocity (position), according to the coordinate transformation defined by the force/velocity allocation-by-function transformation block FT. The ideal velocity (position) source block PC has therein a target value related to a velocity (position) for performing the arithmetic operation based on the coordinate transformation defined by the force/velocity allocation-by-function transformation block FT. This target value is set as a fixed value or a variable value according to the function to be realized. For example, in the case of realizing a function similar to the function indicated by the reference value, the target value is set to be zero. In the case of performing scaling, the target value can be set to be a value obtained by enlarging or reducing information indicating the function to be reproduced.

The inverse transformation block IFT is a block that transforms the value of the region of velocity (position) and the value of the region of force into a value (e.g., a voltage value or a current value) of a region of input to the control target system S. With this basic principle, when information of position of the actuator of the control target system S is inputted to the force/velocity allocation-by-function transformation block FT, information of velocity (position) and force that is obtained based on the information of position is used so that in the force/velocity allocation-by-function transformation block FT, control laws of the region of position and the region of force are applied in accordance with the function. In the ideal force source block FC, an arithmetic operation of force is performed according to the function. In the ideal velocity (position) source block PC, an arithmetic operation of velocity (position) is performed according to the function. The control energy is then distributed. to the force and the velocity (position).

The results of the arithmetic operations in the ideal force source block FC and the ideal velocity (position) source block PC serve as information indicating a control target of the control target system S. The inverse transformation block IFT transforms these arithmetic operation results into an input value for the actuator, and the input value is inputted to the control target system S. As a result, the actuator of the control target system S performs motion according to the function defined by the force/velocity allocation-by-function transformation block FT, and thus, intended motion of the robot is realized. In other words, the present invention enables a robot to realize a physical action of a human being more suitably.

### Examples of Definable Functions

Next, specific examples of functions definable by the force/velocity allocation-by-function transformation block FT will be described. In the force/velocity allocation function transformation block FT, the coordinate transformation (transformation from a real space to a virtual space, corresponding to the function to be realized) is defined, the coordinate transformation to be performed on a velocity (position) and a force that are obtained based on the inputted current position of the actuator. In the force/velocity allocation-by-function transformation block FT, the velocity (position) and the force based on the current position, and a velocity (position) and a force as the reference values of the function are utilized a inputs, respective control laws for the velocity (position) and the force are applied in an acceleration dimension. Specifically, the force of the actuator is expressed as the product of a mass and an acceleration, and a velocity (position) of the actuator is expressed as the integral of the acceleration. Therefore, controlling the velocity (position) and the force through a region of acceleration makes it possible to obtain the current position of the actuator and to realize a target function.

In the following, examples of various functions will be specifically described.

### Force/Haptic Sense Transmission Function

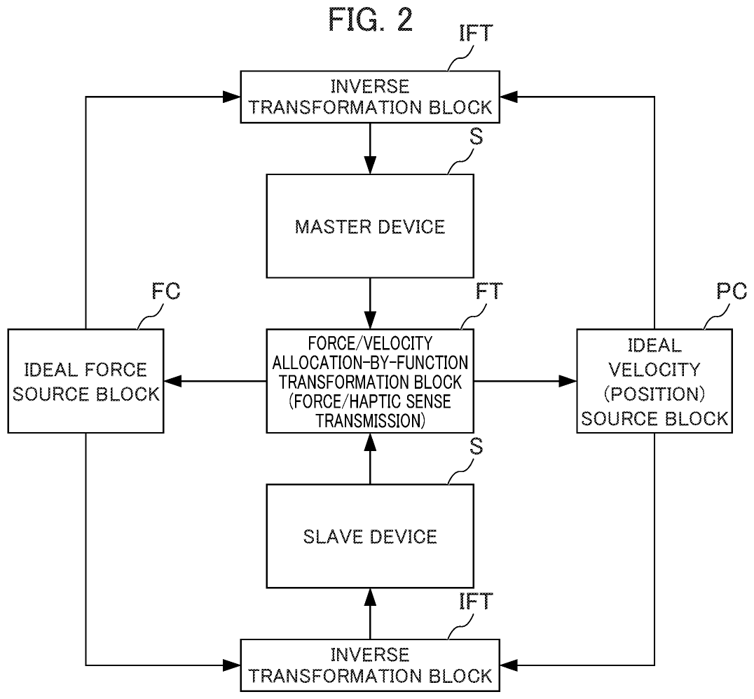

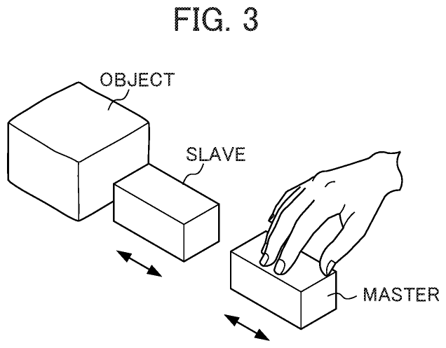

FIG. 2 is a schematic diagram illustrating a concept of control in a case where a force/haptic sense transmission function is defined by the force/velocity allocation-by-function transformation block FT. FIG. 3 is a schematic diagram illustrating a concept of a master-slave system to which the force/haptic sense transmission function is applied and which includes a master device and a slave device. As shown in FIG. 2, as a function defined by the force/velocity allocation-by-function transformation block FT, a function (bilateral control function) can be realized by which motion of the master device is transmitted to the slave device, and an input of a reaction force applied by an object to the slave device is fed back to the master device. In this case, the coordinate transformation is the force/velocity allocation-by-function transformation block FT is expressed by Formulas (3) and (4) below.

$$\begin{matrix}( \begin{matrix}{\dot{x}}_{p} \\ {\dot{x}}_{f}\end{matrix} ) = ( \begin{matrix}1 & - 1 \\ 1 & 1\end{matrix} ) ( \begin{matrix}{\dot{x}}_{m} \\ {\dot{x}}_{s}\end{matrix} ) & ( 3 ) \\ ( \begin{matrix}{f}_{p} \\ {f}_{f}\end{matrix} ) = ( \begin{matrix}1 & - 1 \\ 1 & 1\end{matrix} ) ( \begin{matrix}{f}_{m} \\ {f}_{s}\end{matrix} ) & ( 4 )\end{matrix}$$

In Formula (3) x′ₚ, is a velocity for deriving a state value of velocity (position), and x′_{f} is a velocity related to a state value of force. Further, x′ₘ is a velocity (a differential value of a current position of the master device) of the reference value (an input from the master device), and x′ₛ is a current velocity (differential value of a current position) of the slave device. In Formula (4), fₚ is a force related to the state value of velocity (position), and f_{f} is a force for deriving the state value of force. Further, fₘ is a force of the reference value (input from the master device), and fₛ is a current force of the slave device.

### Pick-and-Place Function

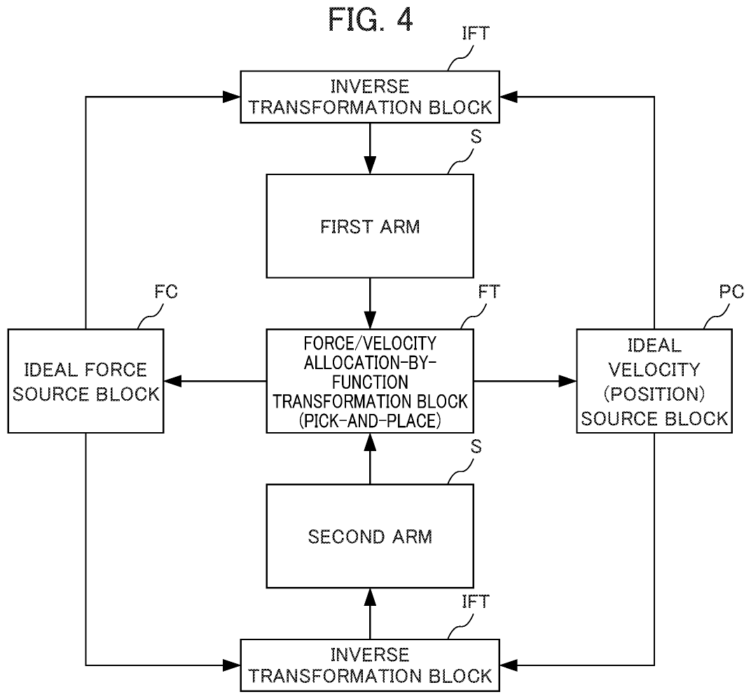

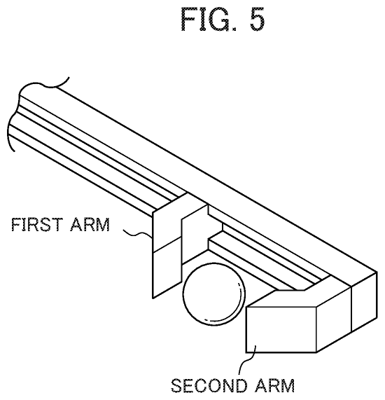

FIG. 4 is a schematic diagram illustrating a concept of control in a case where a pick-and-place function is defined by the force/velocity allocation-by-function transformation block FT. FIG. 5 is a schematic diagram illustrating a concept of a robot arm system to which the pick-and-place function is applied and which includes a first arm and a second arm.

As shown in FIG. 4, as a function defined by the force/velocity allocation-by-function transformation block FT, the function (pick-and-place function) can be realized by which an object such as a workpiece is grasped (picked), conveyed to a target position, and released (placed) there. In this case, the coordinate transformation in the force/velocity allocation-by-function transformation block FT is expressed by Formulas (5) and (6) below.

$$\begin{matrix}( \begin{matrix}{\dot{x}}_{mani} \\ {\dot{x}}_{grasp}\end{matrix} ) = ( \begin{matrix}1 & 1 \\ 1 & - 1\end{matrix} ) ( \begin{matrix}{\dot{x}}_{1} \\ {\dot{x}}_{2}\end{matrix} ) & ( 5 ) \\ ( \begin{matrix}{f}_{mani} \\ {f}_{grasp}\end{matrix} ) = ( \begin{matrix}1 & 1 \\ 1 & - 1\end{matrix} ) ( \begin{matrix}{f}_{1} \\ {f}_{2}\end{matrix} ) & ( 6 )\end{matrix}$$

In Formula (5), x′ₘₐₙᵢ is a velocity for deriving a state value of velocity (position), and x′_{qrasp} is a velocity related to a state value of force. Further, x′₁ is a velocity (differential of a current position) of the first arm, and x′₂ is a velocity (differential of a current position) of the second arm. In Formula (6), fₘₐₙᵢ is a force related to the state value of velocity (position), and f_{grasp} is a force for deriving the state value of force. Further, f₁ is a reaction force that the first arm receives from the object, and f₂ is a reaction force that the second arm receives from the object.

### Function of Learning and Reproducing How to Turn a Screw

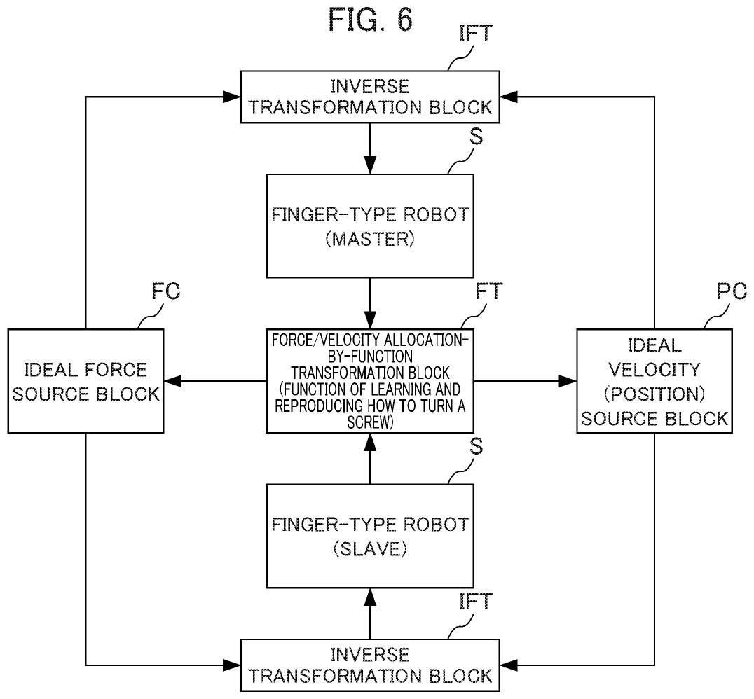

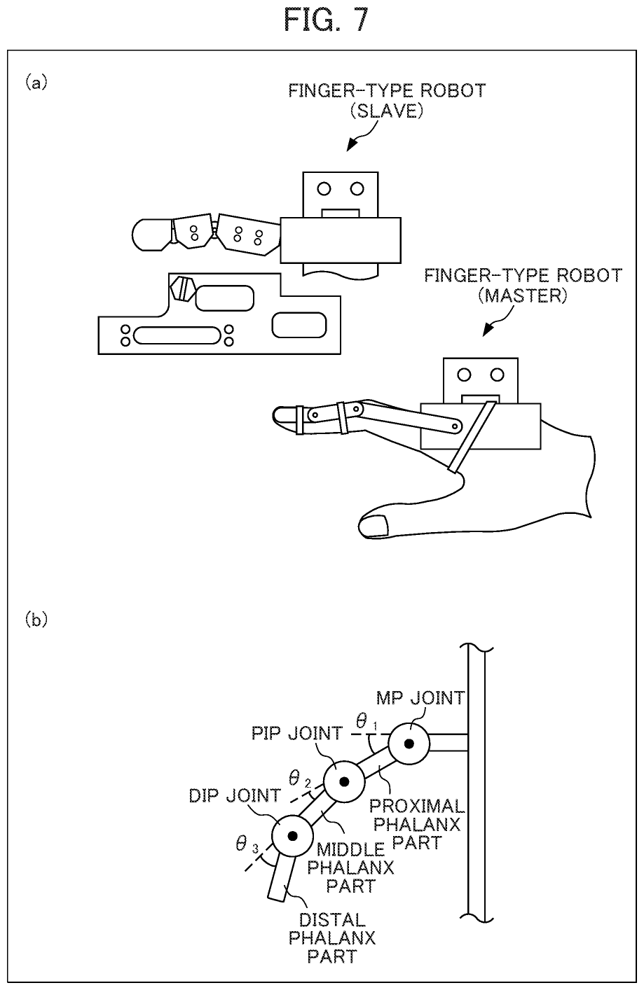

FIG. 6 is a schematic diagram illustrating a concept of control in a case where a function of learning and reproducing how to turn a screw is defined by the force/velocity allocation-by-function transformation block FT. FIG. 7 is a schematic diagram illustrating a robot to which the function of learning and reproducing how to turn a screw is applied. FIG. 7(a) is a schematic diagram illustrating a concept of a master-slave system to which the function of learning and reproducing how to turn a screw is applied and which includes a finger-type master robot and a finger-type slave robot. FIG. 7(b) is a schematic diagram illustrating a finger mechanism of the finger-type robot. As shown in FIG. 6, as a function defined. by the force/velocity allocation-by-function transformation block FT, the function of learning and reproducing how to turn a screw can be realized, by which function a screw is tightened and loosened as a finger is bent and unbent. In this case, the coordinate transformation in the force/velocity allocation-by-function transformation block FT is expressed by Formulas (7) and (8) below.

$$\begin{matrix}( \begin{matrix}{\dot{x}}_{a 1} \\ {\dot{x}}_{a 2} \\ {\dot{x}}_{a 3} \\ {\dot{x}}_{τ1} \\ {\dot{x}}_{τ2} \\ {\dot{x}}_{τ3} \\ {\dot{x}}_{t 1} \\ {\dot{x}}_{t 2}\end{matrix} ) = ( \begin{matrix}\frac{2}{11} & \frac{2}{11} & \frac{4}{11} & \frac{- 3}{11} & \frac{- 3}{11} & \frac{4}{11} & \frac{2}{11} & \frac{2}{11} \\ \frac{3}{11} & \frac{3}{11} & \frac{- 5}{11} & \frac{1}{11} & \frac{1}{11} & \frac{- 5}{11} & \frac{3}{11} & \frac{3}{11} \\ \frac{1}{2} & \frac{- 1}{2} & 0 & 0 & 0 & 0 & \frac{- 1}{2} & \frac{1}{2} \\ 1 & 1 & 1 & - 1 & 1 & - 1 & - 1 & - 1 \\ 1 & 1 & - 1 & 0 & 0 & 1 & - 1 & - 1 \\ 1 & - 1 & 0 & 0 & 0 & 0 & 1 & - \\ 1 & 1 & 2 & 4 & 0 & 0 & 0 & 0 \\ 0 & 0 & 0 & 0 & 4 & 2 & 1 & 1\end{matrix} ) ( \begin{matrix}{\dot{x}}_{1} \\ {\dot{x}}_{2} \\ {\dot{x}}_{3} \\ {\dot{x}}_{4} \\ {\dot{x}}_{5} \\ {\dot{x}}_{6} \\ {\dot{x}}_{7} \\ {\dot{x}}_{8}\end{matrix} ) & ( 7 ) \\ ( \begin{matrix}{f}_{a 1} \\ {f}_{a 2} \\ {f}_{a 3} \\ {f}_{τ1} \\ {f}_{τ2} \\ {f}_{τ3} \\ {f}_{t 1} \\ {f}_{t 2}\end{matrix} ) = ( \begin{matrix}\frac{2}{11} & \frac{2}{11} & \frac{4}{11} & \frac{- 3}{11} & \frac{- 3}{11} & \frac{4}{11} & \frac{2}{11} & \frac{2}{11} \\ \frac{3}{11} & \frac{3}{11} & \frac{- 5}{11} & \frac{1}{11} & \frac{1}{11} & \frac{- 5}{11} & \frac{3}{11} & \frac{3}{11} \\ \frac{1}{2} & \frac{- 1}{2} & 0 & 0 & 0 & 0 & \frac{- 1}{2} & \frac{1}{2} \\ 1 & 1 & 1 & - 1 & 1 & - 1 & - 1 & - 1 \\ 1 & 1 & - 1 & 0 & 0 & 1 & - 1 & - 1 \\ 1 & - 1 & 0 & 0 & 0 & 0 & 1 & - \\ 1 & 1 & 2 & 4 & 0 & 0 & 0 & 0 \\ 0 & 0 & 0 & 0 & 4 & 2 & 1 & 1\end{matrix} ) ( \begin{matrix}{f}_{1} \\ {f}_{2} \\ {f}_{3} \\ {f}_{4} \\ {f}_{5} \\ {f}_{6} \\ {f}_{7} \\ {f}_{8}\end{matrix} ) & ( 8 )\end{matrix}$$

In Formula (7), x′ₐ₁ is a velocity response value related to an angle of an MP joint, x′ₐ₂ is a velocity response value related to an angle of a PIP joint, and x′ₐ₃ is a velocity response value related to an angle of a DIP joint. Further, x′_{τ1} is a velocity response value relate to a torque of the MP joint; x′_{τ2} is a velocity response value related to a torque of the PIP joint; x′_{τ3} is a velocity response value related to a torque of the DIP joint; x′ₜ₁ is a velocity response value related to a tension of wires W1 to W4 of the finger-type master robot; x′ₜ₂ is a velocity response value related to a tension of wires W5 to W8 of the finger-type slave robot; x′₁ to x′₄ are velocity response values of the wires W1 to W4 coupled to the finger-type master robot, respectively; and x′₅ to x′₈ are velocity response values of the wires W5 to W8 coupled to the finger-type slave robot, respectively. The angle of the MP joint, the angle of the PIP joint, and the angle of the DIP joint are defined as θ₁ to θ₃ shown in in FIG. 7(b). In Formula (8), fₐ₁ is a force response value related to the angle of the MP joint; fₐ₂ is a force response value related to the angle of the PIP joint; and fₐ₃ is a force response value related to the angle of the DIP joint. Further, f_{τ1} is a force response value related to the torque of the MP joint; f_{τ2} is a force response value relate to the torque of the PIP joint; f_{τ3} is a force response value related to the torque of the DIP joint; fₜ₁ is a force response value related to the tension of the wires W1 to W4 of the finger-type master robot; fₜ₂ is a force response value related to the tension of the wires W5 to W8 of the finger-type slave robot; f₁ to f₄ are force response values of the wires W1 to W4 coupled to the finger-type master robot, respectively; and A₅ to f₈ are force response values of the wires W5 to W8 coupled to the finger-type slave robot, respectively.

### Basic Configuration of Position/Force Control Device

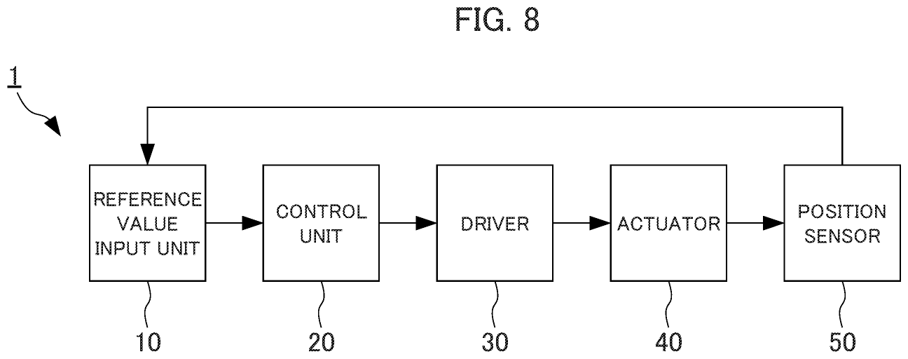

Next, a basic configuration of a position/force control device 1 to which the basic principle of the present invention is applied will be described. FIG. 8 is a schematic diagram showing the basic configuration of the position/force control device 1 according to the present invention. In FIG. 8, the position/force control device 1 includes a reference value input unit 10, a control unit 20, a driver 30, an actuator 40, and a position sensor 50. The position/force control device 1 is configured to operate as a slave device that corresponds to motion of a master device (not shown), and performs motion according to a function, in response to an input of a detection result of a position sensor provided at an actuator of the master device. As will be described later, the position/force control device 1 implements various functions in a switchable manner by way of switching of the coordinate transformations defined by the force/velocity allocation-by-function transformation block FT of the control unit 20.

The reference value input unit 10 inputs a value (reference value) serving as a reference for each function of the position/force control device 1, to the control unit 20. This reference value is composed of, for example, detected time-series values outputted from the position sensor provided at the actuator of the master device. In a case where the detected time-series values from the master device are inputted in real time as the reference value to the control unit 20, the reference value input unit 10 can be constituted by a communication interface (communication I/F). In a case where the detected time-series values of the master device are stored and sequentially read as the reference value to be inputted to the control unit 20, the reference value input unit 10 can be constituted by a storage device such as a memory or a hard disk.

The control unit 20 is configured to control the whole position/force control device 1, and is constituted by an information processing device such as a central processing unit (CPU). Further, the control unit 20 has the functions of the force/velocity allocation-by-function transformation block FT, the ideal force source block FC, the ideal velocity (position) source block PC, and the inverse transformation block IFT, which are shown in FIG. 1. That is, the control unit 20 receives the detected time-series values that are inputted thereto via the reference value input unit 10, the time-series values having been detected by the position sensor of the master device. The detected time-series values represent motion of the master device. The control unit 20 applies a coordinate transformation that is set according to a function, to information of velocity (position) and force that has been derived from the detected values (positions) that have been inputted.

The control unit 20 then performs an arithmetic operation in the region of velocity (position), with respect to a velocity (position) for deriving a state value of velocity (position), obtained by the coordinate transformation. Likewise, the control unit 20 performs an arithmetic operation in the region of force, with respect to a force for deriving a state value of force, obtained the coordinate transformation. Further, the control unit 20 processes the result of the arithmetic operation in the region or velocity (position) and the result of the arithmetic operation in the region of force so as to dimensionally unify the results into acceleration or the like, and applies the inverse transformation of the coordinate transformation that is set in accordance with the function. In this way, the control unit 20 transforms the result of the arithmetic operation in the region of velocity (position) and the result of the arithmetic operation in the region of force into a value of a region of input to the actuator.

The driver 30 transforms the value of the region of input to the actuator, which has been inversely transformed by the control unit 20, into a specific control command value for the actuator 40 (e.g., a voltage value or a current value), and outputs the control command value to the actuator 40. The actuator 40 is driven according to the control command value inputted from the driver 30, and controls the position of a control target. The position sensor 50 detects the position of the control target controlled by the actuator 40, and outputs the detected value to the control unit 20.

With the configuration described above, the position/force control device 1 transforms, by the coordinate transformation according to the function, a velocity (position) and a force that are obtained from the position of the control target detected by the position sensor 50 into a state value of the region of velocity (position) and a state value of the region or force. Consequently, the control energy is distributed to the velocity (position) and the force, according to the function. The respective state values are then inversely transformed into a control command value, according to which the actuator 40 is driven by the driver 30. Thus, by detecting the position of the control target, the position/force control device 1 can calculate the state value of velocity (position) and the state value of force that are required to realize an intended function, and can drive the actuator 40 based on these state values, thereby controlling and bringing the position and the force of the control target into an intended state.

Further, the position/force control device 1 can implement different functions by switching the coordinate transformations of the control unit 20 that corresponds to the functions. For example, a storage device included in the position/force control device 1 stores coordinate transformations that correspond to a plurality of functions on a one-to-one basis, and one coordinate transformation corresponding to the associated function is selected according a purpose. In this way, the position/force control device 1 can implement various functions. Further, the position/force control device 1 can utilize, as the reference values inputted to the control unit 20, acquired values of position and force that are inputted in real time from the master device. In this case, the position/force control device 1 can be controlled in real time in conjunction with motion of the master device. Further, the position/force control device 1 can utilize, as the reference values inputted to the control unit 20, acquired time-series values of position and force of the master device or the slave device that have been acquired and stored in advance. In this case, the functions or the position/force control device 1 can implemented based on previously prepared motion of the master device. In other words, the position/force control device 1 can reproduce an intended function in the absence of the master device.

### Specific Examples of Position/Force Control Device

Specific examples of the position/force control device will be described below.

### Specific Example of Position/Force Control Device for Implementing Function Recording and Re-Executing Action

In order to cause a robot to realize a human physical action for a human being, a situation is conceivable in which a physical action performed by the human being or the like is recorded and the robot is caused to re-execute (reproduce) the recorded physical action. In this case, it is extremely important to perform control so that the time intervals at the time of recording the action are the same as the time intervals at the time of re-executing the actions. For example, if a sampling cycle at the time of recording the action is different from a control cycle at the time of re-executing the action, the action is re-executed at a speed different from that at the time of recording the action. Alternatively, if an intermediate portion of data is missed, the action to be re-executed will be discontinuous.

Here, according to the known techniques, time intervals at the time of recording an action and time intervals at the time of re-executing the action are controlled to be the same only under limited execution conditions. For example, if a device used at the time of recording the action and a device used at the time of re-executing the action have the same specification and their operating conditions are set to be the same, the time intervals at the time of recording the action and the time interval at the time of re-executing the action are controlled to be the same. However, the device actually used at the time of re-executing the action is not always the same as the device used at the time of recording. In addition, the operating conditions of the devices are considered to be different. Therefore, according to the known techniques, it is not ensured that the time intervals at the time of recording an action and the time intervals at the time of re-executing the action are controlled to be the same, and consequently the action may be re-executed improperly. To address this problem, the present embodiment achieves a position/force control device which is capable of causing a robot to re-execute a physical action at the same time intervals as the time intervals at the time of recording the action.

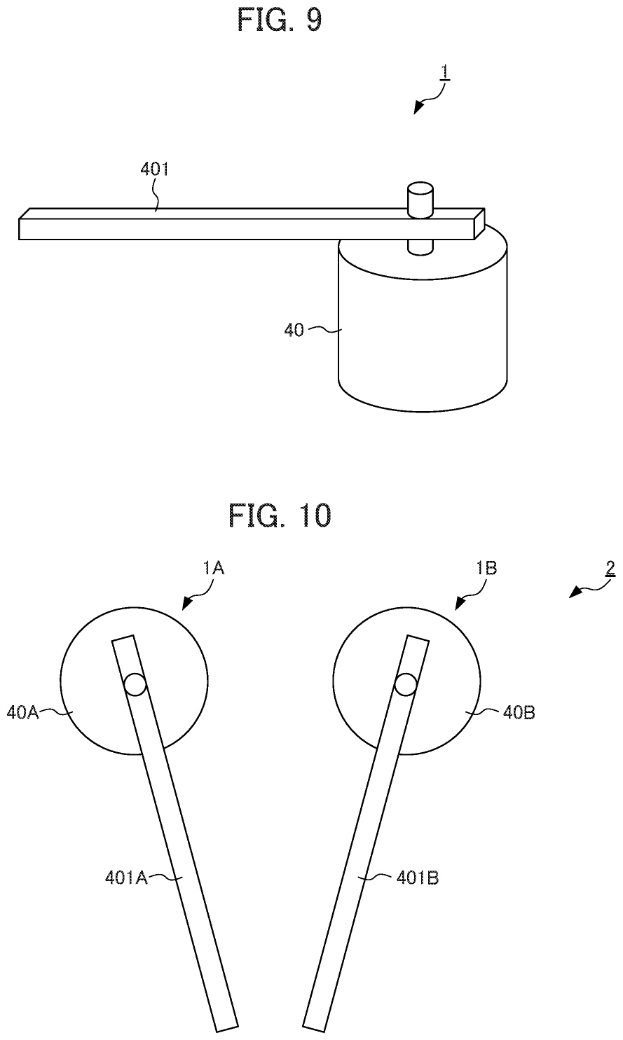

FIG. 9 is a schematic diagram showing a configuration of a position/force control device 1 configured to swing a rod member with the help of an actuator. The position/force control device 1 shown in FIG. 9 is an example of the basic configuration of the position/force control device 1 shown in FIG. 8, and has a configuration in which the rod member 401 is fixed to a rotary shaft of the actuator 40. A position (angle) of the rotary shaft of the actuator 40 is sequentially detected by a position sensor such as an encoder.

FIG. 10 is a schematic diagram (top view) showing a configuration of a position/force control device 2 that is constituted by a combination position/force control devices 1A, 1B having the configuration shown in FIG. 9, and is embodied as a chopstick-type grasping device. As shown in FIG. 10, the position/force control devices 1A, 1B are arranged side-by-side, and rod members 401A, 401B are turned in opposite directions by actuators 40A, 40B, whereby an object is grasped and released. That is, in the position/force control device 2, the rod members 401A, 401B realize motion of chopsticks to grasp an object.

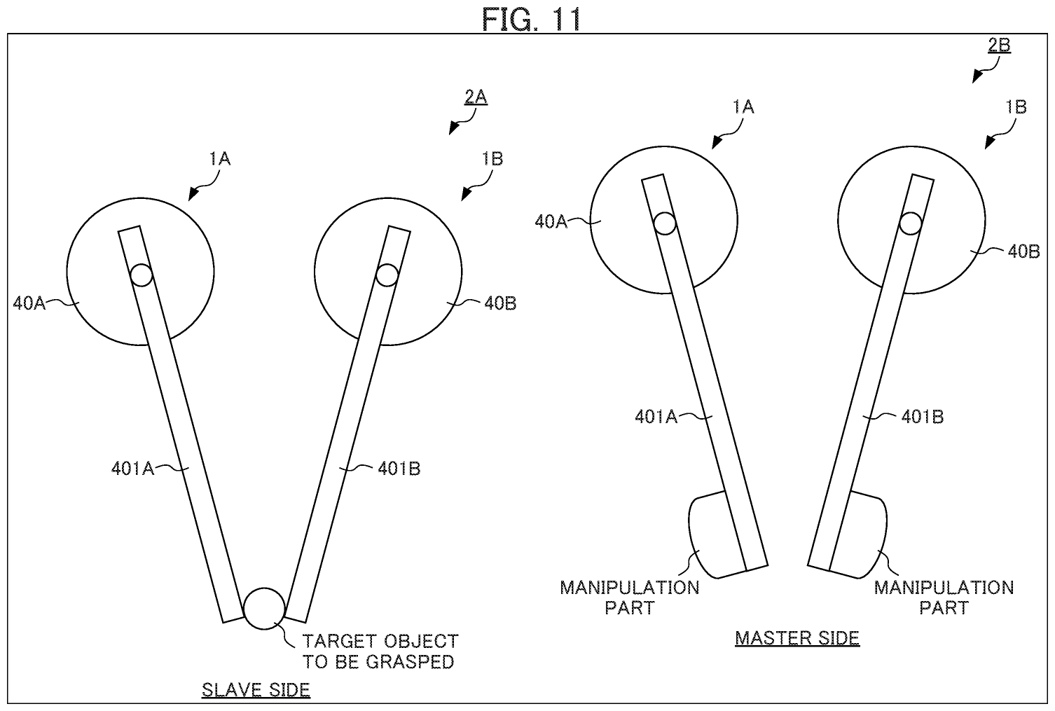

FIG. 11 is a schematic diagram showing a configuration in which position/force control devices 2A, 2B having the configuration shown in FIG. 10 are combined to form a master-slave type grasping device. As shown in FIG. 11, the position/force control device 2A operates as a slave device while the position/force control device 2B operates as a master device. In a control unit 20 (not shown), as a function defined by a force/velocity allocation-by-function transformation block FT, a function (bilateral control function) is realized by which motion of the position/force control device 2B (master device) is transmitted to the position/force control device 2A (slave device), and by which an input of a reaction force applied to the position/force control device 2A by the object is fed back to the position/force control device 2B.

The rod members 401A, 401B of the position/force control device 2B are each provided with a manipulation part for allowing a human being to perform grasping motion. An operator who operates the position/force control device 2B performs the grasping motion with chopsticks while holding the manipulation parts. Consequently, the motion of the position/force control device 2B is transmitted to the position/force control device 2A, and the object is grasped by the position/force control device 2A. At this time, an input of the reaction force applied by the object is transmitted from the position/force control device 2A to the position/force control device 2B, whereby the operator can feel a haptic sense of the force of the object. A storage unit 60 or the like stores the values detected by the position sensor during this control process (or values for deriving state values, resulting from a coordinate transformation performed by the control unit 20), together with information of the recording time intervals, whereby the grasping action (human physical action) with chopsticks can be recorded.

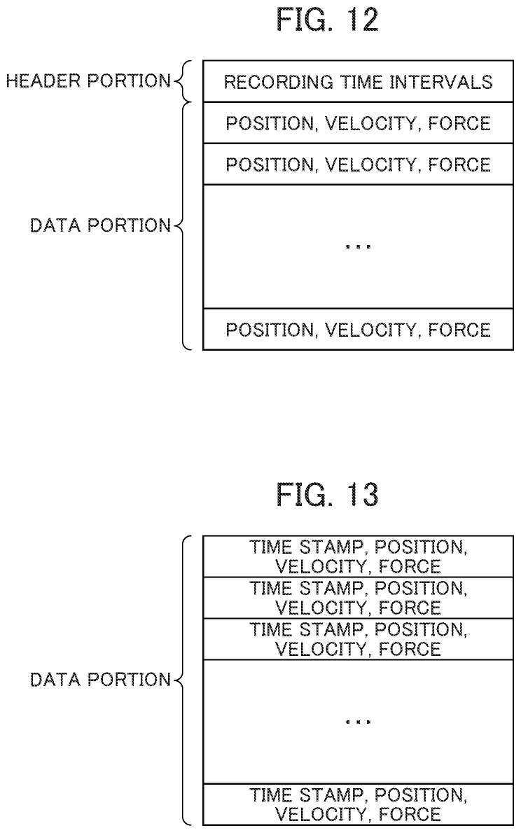

FIG. 12 is a schematic diagram showing an example of a data format in the case of recording a physical action of a human being. As shown in FIG. 12, to record a physical action of a human being, a data format is usable in which information about recording time intervals (e.g., a sampling cycle, etc.) is recorded as a header portion of the data, and a series of data of respective points of time that have been acquired in a time series manner is arranged as a data portion representing the contents of the data. The information of the grasping action with chopsticks recorded in the format shown in FIG. 12 is read and sequentially executed at the recording time intervals, whereby the action can be re-executed at the same time intervals as those at the time of recording the action.

FIG. 13 is a schematic diagram showing another example of a data format in the case of recording a physical action of a human being. Unlike the data format of FIG. 12 in which the information about the recording time intervals is recorded in the header portion of the data, in the data format of FIG. 13, a time stamp representing an point of time is added to each of items of the data acquired at the respective points of time. Also in this case, the recorded information of the grasping action with chopsticks is read and sequentially executed at the recording time intervals, whereby the action can be re-executed at the same time intervals as those at the time of recording the action.

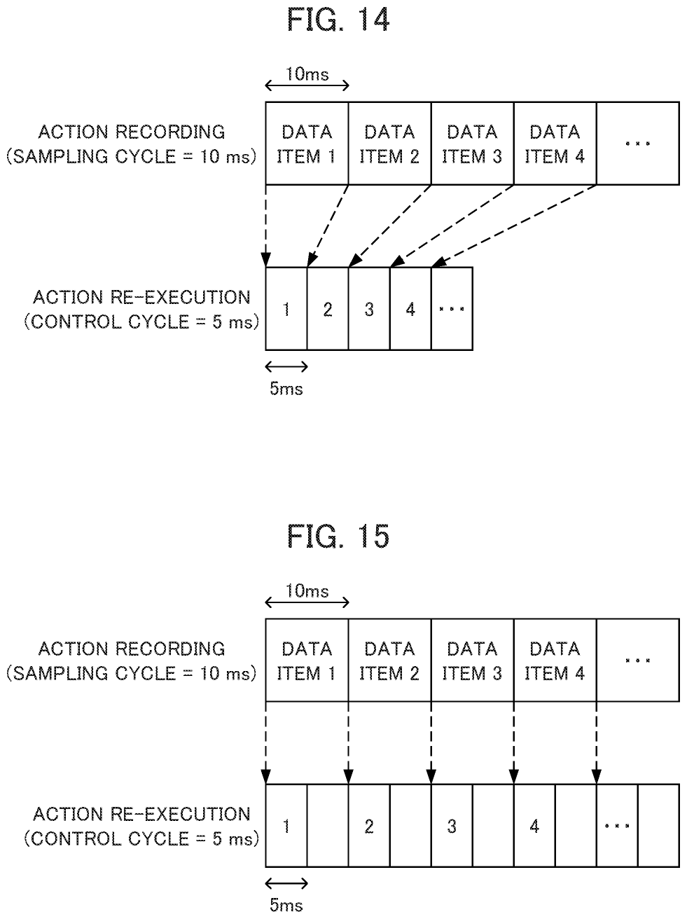

FIG. 14 is a schematic diagram illustrating an example of a result of re-execution of a recorded action in the case where information about the recording time intervals is not recorded. FIG. 15 is a schematic diagram illustrating an example of a result of re-execution of a recorded action in the case where information about the recording time intervals is recorded (in the data format of FIG. 12 or 13). If the sampling cycle of a device used to record the action is 10 [ms] while the control cycle of a device used to re-execute the action is 5 [ms] as shown in FIG. 14, a reproduction speed at which the action is reproduced differs from a speed at the time of recording the action. In contrast, as shown in FIG. 15, in the case where the information about the recording time intervals is recorded, the recorded action is executed at an appropriate timing. Thus, the action can be reproduced at a reproduction speed that is the same as the speed at the time of recording the action, regardless of the specifications and operating conditions of the device used to record the action and the device used to re-execute the action.

### Specific Example of Position/Force Control Device for Realizing Function of Correcting Action

To cause a robot to suitably realize a human physical action for a human being, it is extremely important that the robot is operable in a practical use environment. Here, according to the known techniques, a physical action of a human being is extracted in a human coordinate system, and a robot is caused to re-execute the extracted action. However, these techniques are based on the precondition that a surrounding environment and a state of the robot (an initial posture, etc.) are within a specified range, and do not take account of practical changes in an environment and discontinuity of an action. In view of this, the present embodiment achieves a position/force control device which enables a robot to adapt to a change in a re-execution environment, and to re-execute an action continuously when the robot re-executes the physical action.

As an example, when an action is recorded in, for example, the data format of FIG. 12 or 13, it is conceivable that there is a difference (e.g., a difference in the size of the target object to be grasped) between an environment in which the action is re-executed and an environment at the time of recording the action. To address this, the position/force control device according to the present embodiment can conduct a correction of action when a robot re-executes a physical action in the case where the re-execution environment differs from that at the time of recording the action.

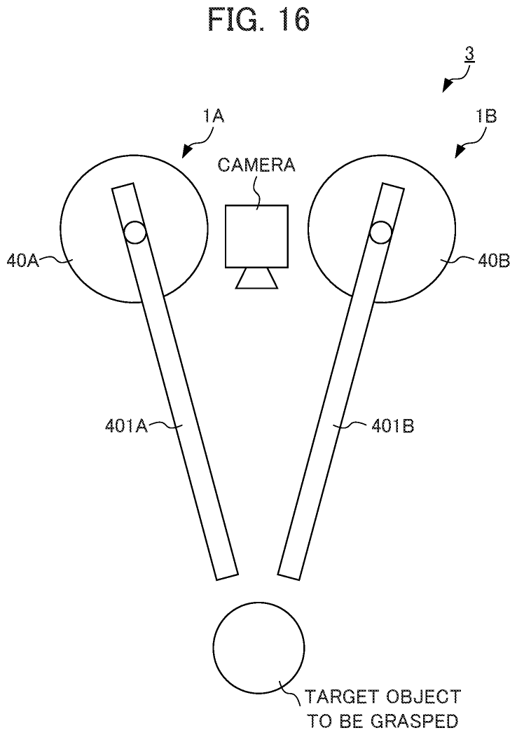

FIG. 16 is a schematic diagram showing a configuration of a position/force control device 3 provided with a camera as an environment recognizer. Note that the position/force control device 3 shown in FIG. 16 has a configuration corresponding to that of the chopstick-type grasping device of FIG. 10 with addition of the camera for capturing an image of a target object to be grasped. When re-executing contents of a recorded grasping action, the position/force control device 3 shown in FIG. 16 recognizes the size of the target object to be grasped by way of the camera so as to correct an extent of opening/closing of the chopsticks of the recorded grasping action to an extent suitable for the target object to be grasped, thereby re-executing the action. For example, when the size of the object recognized by the camera is 1.2 times larger than the extent of opening for grasping, the extent being retained in action contents, a corrected value is used which is obtained by multiplying position-related information included in the control reference (reference values) inputted at the time of re-execution by 1.2, so that the action adapted to the environment can be re-executed.

### Specific Example of Action Expressing Method Executed by Position/Force Control Device

In order to cause a robot to realize every physical action of a human being, it is extremely important that specified actions (action contents) can be produced and edited flexibly and easily. Here, according to the known techniques, a physical action of a human being is extracted in a human coordinate system, and a robot is caused to re-execute the extracted action. These techniques are based on the precondition that the data about the position and force of the robot is precisely recorded over the entire action, and does not take account of the possibility that a human being intuitively produces and edits action contents. In addition, the amount of data of the action contents may become enormous. To address this, the present embodiment achieves an action expressing method enabling the action contents to be produced and edited flexibly and easily.

The action to be recorded and re-executed in the present embodiment can be expressed by combining a plurality of rules. For example, in the case of an action of the chopstick-type grasping device shown in FIG. 10 to grasp a target object, the contents of the grasping action are composed of a combination of: a rule for generating information that serves as a control reference (rule for recording an action); a rule for generating an event (rule for triggering re-execution of the action); and a rule for switching actions of the plurality of actuators (rule for executing motion).

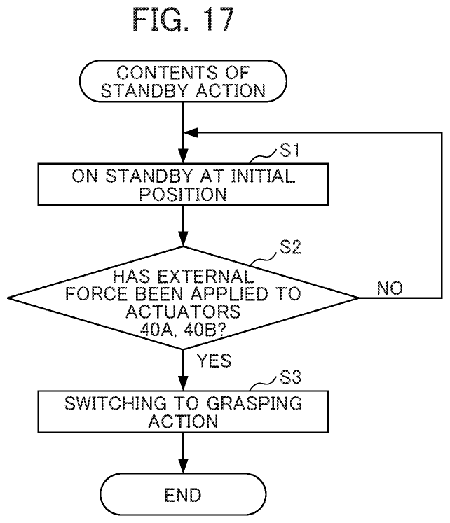

FIG. 17 is a flowchart showing the contents (a combination of rules) of a standby action. In FIG. 17, following start of the standby action, in Step S1, the position/force control device 2 is on standby at an initial position. In Step S2, the position/force control device 2 determines whether an external force has been applied to at least one of the actuator 40A or the actuator 40B. If no external force has been applied both the actuator 40A and the actuator 40B, a determination of “NO” is made in Step S2, and the process proceeds to Step S1. On the other hand, when an external force has been applied to at least one of the actuator 40A or the actuator 40B, a determination of “YES” is made in Step S2, and the process proceeds to Step S3.

In Step S3, the position/force control device 2 switches the action of the actuators 40A and 40B to the grasping action. After Step S3, the standby action ends.

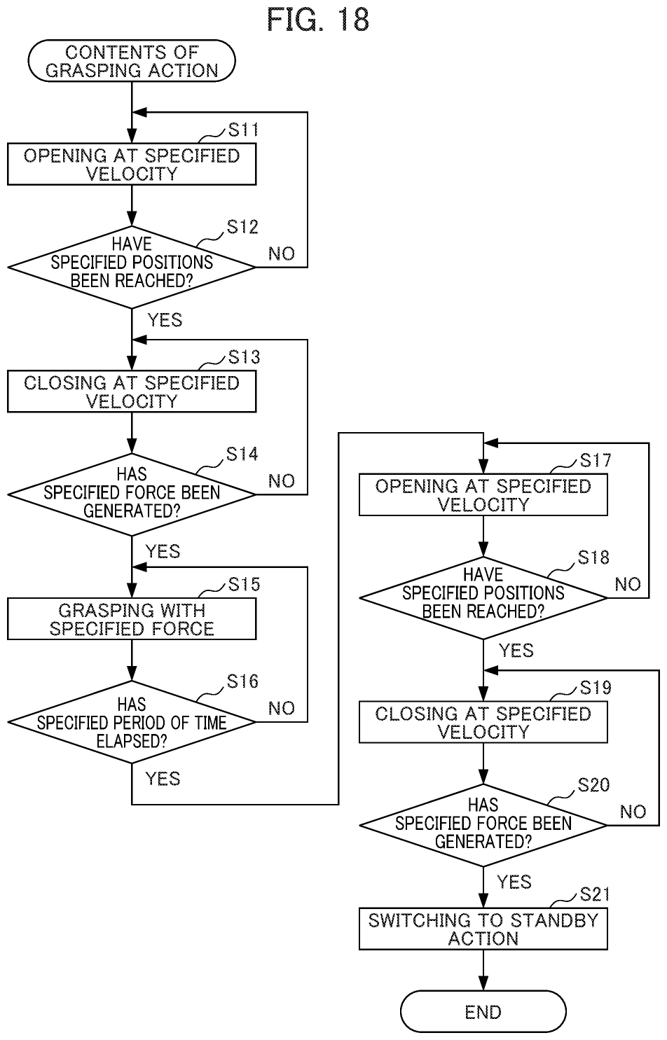

FIG. 18 is a flowchart showing the contents (a combination of rules) of the grasping action. In FIG. 18, following start of the grasping action, in Step S11, the position/force control device 2 opens the rod members 401A, 401B at a specified velocity (recorded velocity). In Step S12, the position/force control device 2 determines whether the rod members 401A, 401B have reached specified positions (recorded positions). If the rod members 401A, 401B have not reached the specified positions (recorded positions), a determination of “NO” is made in Step S12, and the process proceeds to Step S11. On the other hand, if the rod members 401A, 401B have reached the specified positions (recorded positions), a determination of “YES” is made in Step S12, and the process proceeds to Step S13.

In Step S13, the position/force control device 2 closes the rod members 401A, 401B at a specified velocity (recorded velocity). In Step S14, the position/force control device 2 determines whether the force for grasping the target object has reached a specified force (recorded force). If the force for grasping the target object has not reached the specified force (recorded force), a determination of “NO” is made in Step S14, and the process proceeds to Step S13. On the other hand, if the force for grasping the target object has reached the specified force (recorded force), a determination of “YES” is made in Step S14, and the process proceeds to Step S15.

In Step S15, the position/force control device 2 grasps the target object with the specified force (recorded force). In Step S16, the position/force control device 2 determines whether a specified period of time (recorded grasping period) has elapsed. If the specified period of time (recorded grasping period) has not elapsed, a determination of “NO” is made in Step S16, and the process proceeds to Step S15. On the other hand, if the specified period of time (recorded grasping period) has elapsed, a determination of “YES” is made in Step S16, and the process proceeds to Step S17.

In Step S17, the position/force control device 2 opens the rod members 401A, 401B at a specified velocity (recorded velocity). In Step S18, the position/force control device 2 determines whether the rod members 401A, 401B have reached specified positions (recorded positions). If the rod members 401A, 401B have not reached the specified positions (recorded positions), a determination of “NO” is made in Step S18, and the process proceeds to Step S17. On the other hand, if the rod members 401A, 401B have reached the specified positions (recorded positions), a determination of “YES” is made in Step S18, and the process proceeds to Step S19.

In Step S19, the position/force control device 2 closes the rod members 401A, 401B at a specified velocity (recorded velocity). In S20, the position/force control device 2 determines whether the rod members 401A, 401B have reached a specified force (recorded force). If the rod members 401A, 401B have not reached the specified force (recorded force), a determination of “NO” is made in Step S20, and the process proceeds to Step S19. On the other hand, if the rod members 401A, 401B have reached the specified force (recorded force), a determination of “YES” is made in Step S20, and the process proceeds to Step S21. In Step S21, the position/force control device 2 switches the action of the actuators 40A, 40B to the standby action. After Step S21, the grasping action ends.

As can be seen from the foregoing, the contents of the standby action and those of the grasping action are each defined by a combination of rules, and a series of actions can be expressed by a combination of the contents.

### Specific Example of Position/Force Control Device for Estimating Object Properties of Contact Target

In order to cause a robot to realize a human physical action for a human being, it is important that the robot instantaneously understands the object properties of a contact target, such as rigidity, viscosity, and inertia. Here, according to the known techniques, it is possible to make the robot understand the object properties of a contact target only under limited conditions, such as where the object properties are already known, or where a human being understands the object properties by real-time remote operation and teaches the properties to the robot. In view of this, the present embodiment enables a robot itself to estimate the rigidity, viscosity, inertia, and the like of a contact target by way of motion of the robot to contact with the contact target.

The position/force control device 1 of the present embodiment can implement various functions such as grasping an pushing an object, moving an object, cutting an object, and stirring a fluid, by tale coordinate transformation based on Formulas (1) and (2). At this time, the parameters related to the coordinate transformation (such as the state value of velocity or the state value of force) vary according to the object properties of an object as the contact target. In other words, the parameters related to the coordinate transformation calculated when the position force control device 1 contacts with the object come to correspond to the properties of the object. Therefore, the object properties of the contact target can be estimated from the parameters related to the coordinate transformation calculated when the position/force control device 1 contacts with the object.

For example, an actuator is subjected to motion control such that the position, velocity, and acceleration of the actuator change continuously, while the tip (contact) of the actuator is in contact with a target object. From position information of the actuator, the velocity, acceleration, and force are calculated. The position of the actuator, information of the velocity, acceleration, and force, and sequential application of the least square method allows the rigidity, viscos inertia, and the like of the target object to be estimated.

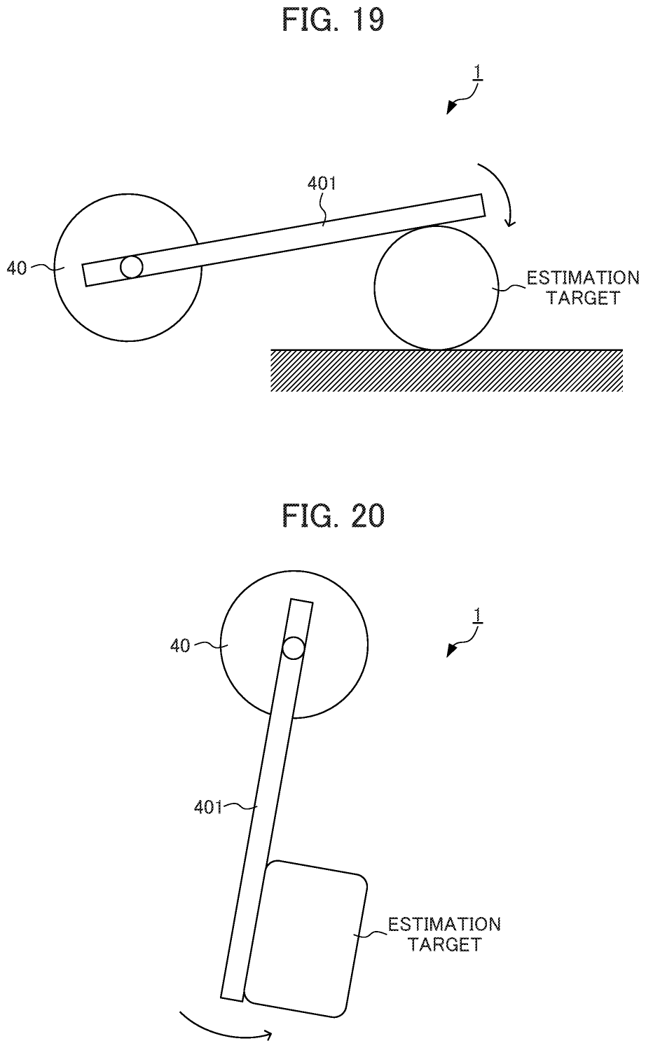

FIG. 19 is a schematic diagram showing a configuration of a position/force control device 1 that estimates object properties while pushing a solid. As shown in FIG. 19, in the case of pushing the stationary solid, the object properties such as rigidity and elasticity of the solid can be estimated from the parameters related to the coordinate transformation. FIG. 20 is a schematic diagram showing a configuration of a position/force control device 1 that estimates object properties while moving a solid. As shown in FIG. 20, in the case of moving the solid, the object properties such as friction and inertia of the solid in motion can be estimated from the parameters related to the coordinate transformation.

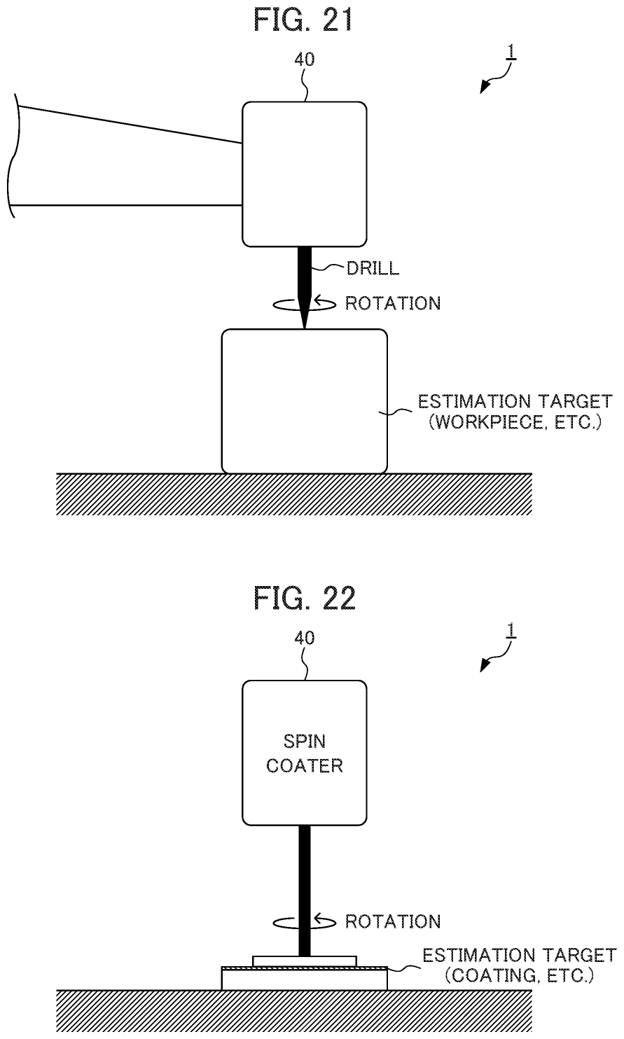

FIG. 21 is a schematic diagram showing a configuration of a position/force control device 1 that estimates object properties while cutting a solid. As shown in FIG. 21, in the case of cutting the solid, the object properties such as hardness and cutting resistance of the solid can be estimated from the parameters related to the coordinate transformation. FIG. 22 is a schematic diagram showing a configuration of a position/force control device 1 that estimates object properties while applying liquid. As shown in FIG. 22, in the case of applying liquid by spin coating or the like, the object properties such as viscosity, shearing stress or shear rate of the liquid can be estimated from the parameters related to the coordinate transformation.

Note that appropriate modifications, improvements, and the like can be made to the present invention within the scope where the effects of the present invention are exerted. Thus, the present invention is not limited to the above-described embodiments and modifications. For example, the present invention can be implemented as, in addition to the position/force control devices of the above-described embodiments, a position/force control method composed of steps performed by the position/force control device, or a program executed by a processor to implement the functions of the position/force control device.

Note that the above embodiments represent examples in which the present invention is adopted, and are not intended to limit the technical scope of the present invention. In other words, various changes such as omission and substitution can be made to the present invention without departing from the spirit of the present invention, and the present invention can also be implemented as various embodiments different from the above-described embodiments. Various possible embodiments of the present invention and variations thereof are encompassed in the scope of the invention defined in the claims and in the scope of equivalents of the invention.

### EXPLANATION OF REFERENCE NUMERALS

S: Control Target System

### FT: Force/Velocity Allocation-by-Function Transformation Block (Force/Velocity Allocation-by-Function Transformer)

### FC: Ideal Force Source Block (Force Control Amount Calculator)

### PC: Ideal Velocity (Position) Source Block (Position Control Amount Calculator)

### IFT: Inverse Transformation Block (Combiner)

### 1A, 1B, 2, 2A, 2B, 3: Position/Force Control Device

### 10: Reference Value Input Unit

### 20: Control Unit

### 30: Driver

### 40, 40A, 40B: Actuator

### 50: Position Sensor (Position Detector)

### 60: Storage Unit

### 401, 401A, 401B: Rod Member

1. A position/force control device comprising:
force/velocity allocation-by-function transformer that performs transformation to allocate control energy to energy of velocity or position and energy of force in accordance with a function to be implemented, based on information or velocity (position) and force corresponding to information about position that is based on an operation of an actuator, and information serving as a reference of control;
a position control amount calculator that calculates a control amount of velocity or position, based on the energy of velocity or position allocated by the force/velocity allocation-by-function transformer;
a force control amount calculator that calculates a control amount of force, based on the energy of force allocated by the force/velocity allocation-by-function transformer;
a combiner that combines the control amount of velocity or position with the control amount of force, and in order to return a resultant output to the actuator, inversely transforms the control amount of velocity or position and the control amount of force, and thereby determines an input to the actuator;
an action time information retainer that retains not only action information, but also time intervals of an action or time stamps while the action is recorded;
a control reference information generator that generates, from recorded action information, information serving as a control reference while the action re-executed;
a control timing determiner that determines, from recorded action time information, timing at which control reference information is outputted while the action is re-executed; and
a position/force controller that re-executes the action, based on the generated control reference information and the determined control timing,
the position/force control device enabling the action to be re-executed at the same time intervals as those in recording of the action.

2. A position/force control device comprising:
a force/velocity allocation-by-function transformer that performs transformation to allocate control energy to energy of velocity or position and energy of force in accordance with a function to be implemented, based on information of velocity (position) and force corresponding to information about position that is based on an operation of an actuator, and information serving as a reference of control;
a position control amount calculator that calculates a control amount of velocity or position, based on the energy of velocity or position allocated by the force/velocity allocation-by-function transformer;
a force control amount calculator that calculates a control amount of force, based on the energy of force allocated by the force/velocity allocation-by-function transformer;
a combiner that combines the control amount of velocity or position with the control amount of force, and in order to return a resultant output to the actuator, inversely transforms the control amount of velocity or position and the control amount of force, and thereby determines an input to the actuator;
an action contents interpreter that extracts, from action contents, information serving as a control reference and including a control target value and/or a control gain;
a position detector that detects position information of the actuator;
an environment recognizer that recognizes environmental information of re-execution of an action;
an action corrector that corrects the information serving as the control reference, based on at least one piece of the position information of the actuator, information of velocity and force corresponding to the position information, time information, and the environmental information; and
a position/force controller that re-executes the action, based on the corrected information serving as the control reference,
the position/force control device enabling the action to be re-executed while adapting the action to an environmental change.

3. A position/force control device comprising:
a force/velocity allocation-by-function transformer that performs transformation to allocate control energy to energy of velocity or position and energy of force in accordance with a function to be implemented, based on information of velocity (position) and force corresponding to information about position that is based on an operation of an actuator, and information serving as a reference of control;
a position control amount calculator that calculates a control amount of velocity or position, based on the energy of velocity or position allocated by the force/velocity allocation-by-function transformer;
a force control amount calculator that calculates a control amount of force, based on the energy of force allocated by the force/velocity allocation-by-function transformer;
a combiner that combines the control amount of velocity or position with the control amount of force, and in order to return a resultant output to the actuator, inversely transforms the control amount of velocity or position and the control amount of force, and thereby determines an input to the actuator;
a control reference expresser that expresses action. contents while retaining rules for generating information serving as a control reference, based on at least one piece of position information of the actuator, information of velocity and force, time information, environmental information, and virtual environmental information;
an event expresser that expresses action contents while retaining rules for generating an event based on at least one piece of the position information of the actuator, the information of velocity and force, the time information, the environmental information, and the virtual environmental information; and
an action switching expression method that expresses switching of the action contents while retaining rules for switching actions of one or more actuators,
the position/force control device enabling the action contents to be expressed flexibly and easily.

4. A position/force control device comprising:
a force/velocity allocation-by-function transformer that performs transformation to allocate control energy to energy of velocity or position and energy of force in accordance with a function to be implemented, based on information of velocity (position) and force corresponding to information about position that is based on an operation of an actuator, and information serving as a reference of control;
a position control amount calculator that calculates a control amount of velocity or position, based on the energy of velocity or position allocated by the force/velocity allocation-by-function transformer;
a force control amount calculator that calculates a control amount of force, based on the energy of force allocated by the force/velocity allocation-by-function transformer;
a combiner that combines the control amount of velocity or position with the control amount of force, and in order to return a resultant output to the actuator, inversely transforms the control amount of velocity or position and the control amount of force, and thereby determines an input to the actuator;
a control reference information generator that generates control reference information from predetermined control reference information or information extracted by way of a real-time remote operation;
a position detector that detects position information of the actuator;
a position/force controller that performs movement control based on the position information of the actuator, information of velocity and force corresponding to the position information, and the generated control reference information; and
an object properties estimator that estimates at least one of rigidity, viscosity, and inertia of a contact target object, based on the position information of the actuator and the information of velocity, acceleration and force corresponding to the position information,
the position/force control device allowing a robot itself to estimate at least one of the rigidity, the viscosity, and the inertia of the contact target object.
